(19) United States
(12) Patent Application Publication
(10) Pub. No.: US 2017/0258064 A1
(43) Pub. Date: Sep. 14, 2017

(54) FISHING LINE GUIDE

(71) Applicant: Mitchell Wayne Grant, Mechanicsville, VA (US)

(72) Inventor: Mitchell Wayne Grant, Mechanicsville, VA (US)

(21) Appl. No.: 15/448,885

(22) Filed: Mar. 3, 2017

Related U.S. Application Data
(60) Provisional application No. 62/304,979, filed on Mar. 8, 2016.

(51) Int. Cl. A01K 91/06; A01K 97/00

(52) U.S. Cl. CPC A01K 91/06; A01K 97/00

(57) ABSTRACT

A fishing line guide is a narrow, elongate shaft having a front end and a back end. The front end has a blunt tip, while the back end includes a fishing line clamp. The fishing line clamp includes an aperture and converging side portions that are adapted to, together, receive a fishing line through the aperture and then releasably securing that line in between the converging side portions.

This application claims the benefit of U.S. Provisional Application No. 62/304,979, filed Mar. 8, 2016 and entitled “Fishing Line Guide Pin”, which is incorporated by reference herein in its entirety.

The present invention relates to a line guide for use in feeding fishing line through guide holes mounted on a fishing rod.

### BACKGROUND

It has been a part of fishing preparation for many years to manually feed a fishing line from a fishing reel through the series of guide holes, also referred to as eyelets, fixed along the length of a fishing rod up to the tip of that rod. It is also common that this chore must be undertaken several times while fishing when the line breaks, when changing a lure or otherwise when changing the tackle that is being used. This chore is a necessary nuisance in the fishing process.

Recently, fishing rods have been engineered to employ smaller guides with smaller guide holes in order to improve casting performance. This is true with respect to both spinning rods and fly rods. The small guide holes have made the feeding of fishing line even more difficult than it previously was.

### SUMMARY

Accordingly, it is an object of the present invention to enable more rapid and accurate feeding of a fishing line through the guide holes of a rod when fishing or preparing to go fishing. The use of the line guide described herein enables persons to accurately, efficiently and quickly feed a fishing line through guide holes.

In one example, a fishing line guide comprises a narrow elongate shaft having a front end and a back end. The front end is blunted. The back end of the shaft comprises a line clamp, wherein the line clamp comprises an aperture and converging clamp side portions that form a v-slot therebetween. The v-slot is adapted to physically pinch a fishing line in between the clamp side portions with a friction grip, whereby a fishing line is adapted to be releasably secured in the clamp end of the line guide to enable a user to efficiently position the fishing line in the guide holes of a fishing rod. The converging clamp side portions that form the v-slot are formed of a single, monolithic and substantially rigid metal piece. Alternatively, the converging clamp side portions that form the v-slot are formed of a pair of metal wire sections, or they may be formed of of a single metal wire section that is bent to create the v-slot. The elongate shaft may be formed from a single, rigid, monolithic metal piece, or alternatively from a single bent wire with a pair of parallel wire portions, or still further alternatively from a single bent wire with a pair of twisted wire portions. The elongate shaft may be coated at least in part, and the coating may be a dye or a plastic coating. The aperture portion of the line clip may have an opening width of about 0.5 to 3 mm. The maximum cross-sectional width of the line guide may be about 2 to 5 mm.

### BRIEF DESCRIPTION OF THE DRAWINGS

FIG. 1 is a perspective view of the end of a fishing rod where a line guide is shown guiding the fishing line through the rod guide holes or eyelets.

FIG. 2 is a top view of a first example of a line guide as described herein with the front end of the guide shown in cross-section.

FIG. 3 is a top view of a second example of a line guide as described herein with the front end of the guide shown in cross-section.

FIG. 4 is a top view of a third example of a line guide as described herein with the front end of the guide shown in cross-section.

FIG. 5 is a top view of a fourth example of a line guide as described herein with the front end of the guide shown in cross-section.

FIG. 6 is a top view of a fifth example of a line guide as described herein with the front end of the guide shown in cross-section.

FIG. 7 is a top view of a sixth example of a line guide as described herein with the front end of the guide shown in cross-section.

FIG. 8 illustrates three alternative end cross-sectional views of a line guide as described herein.

FIG. 9 is a top view of a seventh example of a line guide as described herein with the front end of the guide shown in cross-section.

FIG. 10 is a top view of an eighth example of a line guide as described herein with the front end of the guide shown in cross-section.

FIG. 11 is a top view of a ninth example of a line guide as described herein with the front end of the guide shown in cross-section.

FIG. 12 is a top view of a tenth example of a line guide as described herein with the front end of the guide shown in cross-section.

FIG. 13 is a top view of an eleventh example of a line guide as described herein with the front end of the guide shown in cross-section.

FIG. 14 is a top view of a twelfth example of a line guide as described herein with the front end of the guide shown in cross-section.

FIG. 15 is a perspective view of a thirteenth example of a line guide as described herein.

FIG. 16 is a perspective view of a fourteenth example of a line guide as described herein.

### DETAILED DESCRIPTION

The line guide described herein includes a narrow, elongate shaft with a front end and a back end. The front end is blunted, and the back end comprises a line clamp to receive and removably secure a line during the process of feeding that line through fishing rod guide holes. For purposes of clarity, the line guide may be referred to alternatively as a pin. The line clamp on the back end of the shaft may alternatively be referred to as a clip, which in either event is the structure that physically pinches and removably holds a fishing line by way of a friction fit of the line positioned in the clamp or clip.

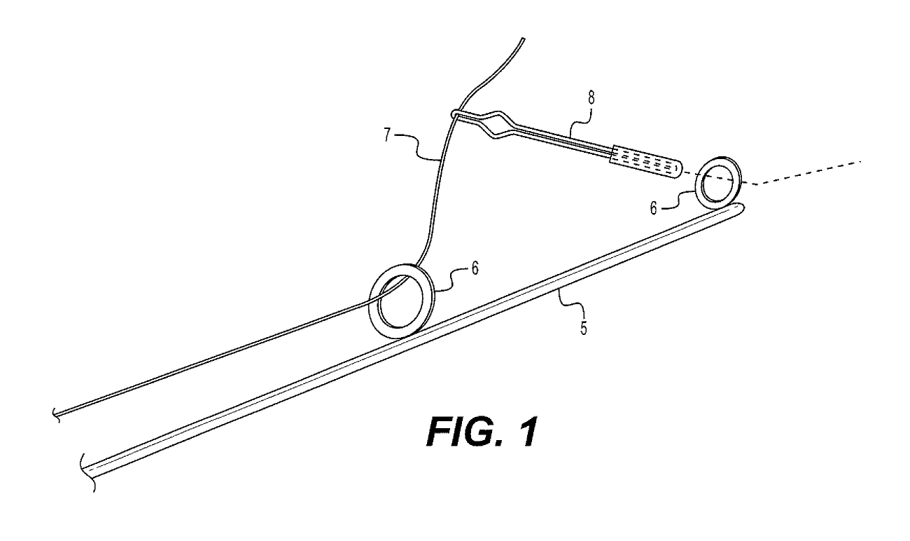

Referring to FIG. 1, it is seen that a fishing rod 5 has guide holes (or eyelets) 6 mounted thereon. The fishing line 7 is guided through the guide holes 6 using one example of a line guide 8. It is understood of course that this drawing is for illustrative purposes only. The guide holes 6 are typically more firmly attached to a rod 5, and those guide holes can be very small—much smaller than represented in FIG. 1.

A line guide includes an elongate shaft that is sized so that its cross-sectional width is narrow enough to fit through a fishing rod guide hole. However, the line guide is wide enough to have substance for easy handling by a user. The line guide may be about 1 to 6 inches in length, or alternatively about 1.5 to 4 inches in length, or still further alternatively about 2 to 3 inches in length.

The line guide may be round in cross-section, or alternatively substantially flat (rectangular in cross-section), or alternatively rounded as in an oval cross-section. Further, the line guide may be round in cross-section for most of its length but flatten out at the front or middle or back portion of the length of the line guide. Similarly, the cross-sectional shape may be otherwise variable according to a fisherman's need or perceived need.

The line guide may be formed from a metal material. Alternatively, the line guide may be made of a plastic, wood, ceramic or composite material. In one example, the line guide is formed of a monolithic, substantially rigid steel and has a powder coating on it to prevent or reduce corrosion. Alternatively, the line guide may be formed of wire segments that are crimped or welded together is a generally parallel or twisted configuration. Still further, the line guide may be formed of a single wire that is bent to form the guide shape and may include substantially parallel wire portions or twisted wire portions as well. Alternatively to coating with a powder coat, the line guide may similarly be otherwise painted. The metal guide pin may also be formed of stainless steel or aluminum. There may also be a plastic coating over the tip or other portions of the line guide shaft.

The surface of the line guide may be painted with a specific color or colors. It is possible that the different colors have different meaning with respect to their use in connection with different rods, for instance. In other words, different rods may have different size guide holes. A more narrow cross-sectional line guide may be required for a fly rod, for instance. Some spinning rods may use wider guides and guide holes, so a relatively wider cross-section line guide may be deployed. The surface of the pin may have different color patterns that highlight the front end and clamp portion of the line guide. It is also possible that the color patterns and/or indicia may be placed on the line guide for brand or promotional purposes.

The front end of the line guide is a rounded or blunted tip. This rounded or blunted tip prevents a user from accidentally poking himself or herself. The tip may be rounded or beveled also to help the feeding of the line guide through the guide holes. Alternatively, the line guide front end may be plastic or rubber coated for safety. It may also be brightly colored to visually assist a user with the feeding process.

The back end of the line guide may be an integral section of the shaft so that the entire line guide is a single monolithic piece. Alternatively, the back end may be welded or soldered or otherwise attached to the end of the shaft opposite the front end of the line guide. The line guide may have a collar to securely attach the front end of the shaft of the line guide to the back end. If a collar is used, it is preferably beveled on its front edge at least to enable better the feeding process.

The line clamp portion of the back end portion of the line guide includes an aperture through which the fishing line is adapted to be inserted. The line clamp also includes converging clamp side portions that form a narrow v-slot. The v-slot is wide enough to receive the fishing line and then also narrow enough to pinch the line between the converging clamp sides of the v-slot to temporarily secure the fishing line in the v-slot and/or between the clamp side portions. The line clamp may be in the form of a wire which defines the aperture and v-slot. Alternatively, the line clamp may be cut out of the back end portion of the line guide, for instance by a laser cut from the monolithic and substantially rigid body of the line guide. The aperture of the back end has a width of about 0.5 to three millimeters, or alternatively about one to two millimeters. This aperture cannot be too large to prevent the feed through some fishing rod guide holes, however it is similarly undesirable if the aperture is too small, because it then becomes difficult to insert the fishing line into it.

In another example, the converging clamp sides of the clamp of the line guide may be literally touching or contacting each other. Especially in the bent wire example, but not limited to this example, parallel wires form the converging clip side portions (and the clamp aperture). These wires are immediately adjacent and may be in contact with each other. In use, a fishing line is pulled into and wedged between the wire clamp side portions that frictionally grip and releasably secure the fishing line therebetween.

The line guide may be generally uniform in cross-sectional width along the length of the shaft. The back end would therefore be integral within the end of the shaft. Alternatively, the cross-section may be the same from the front end back to line clamp, but the clamp may be wider because of the needed aperture for easy use. The maximum cross-sectional width of the line guide at any point along the length is about one to ten millimeters, or alternatively about two to five millimeters. With respect to its length, the guide pin may be about 1 to 12 inches in length, or alternatively about 1.5 to 6 inches in length, or still further alternatively, about 2 to 3 inches in length.

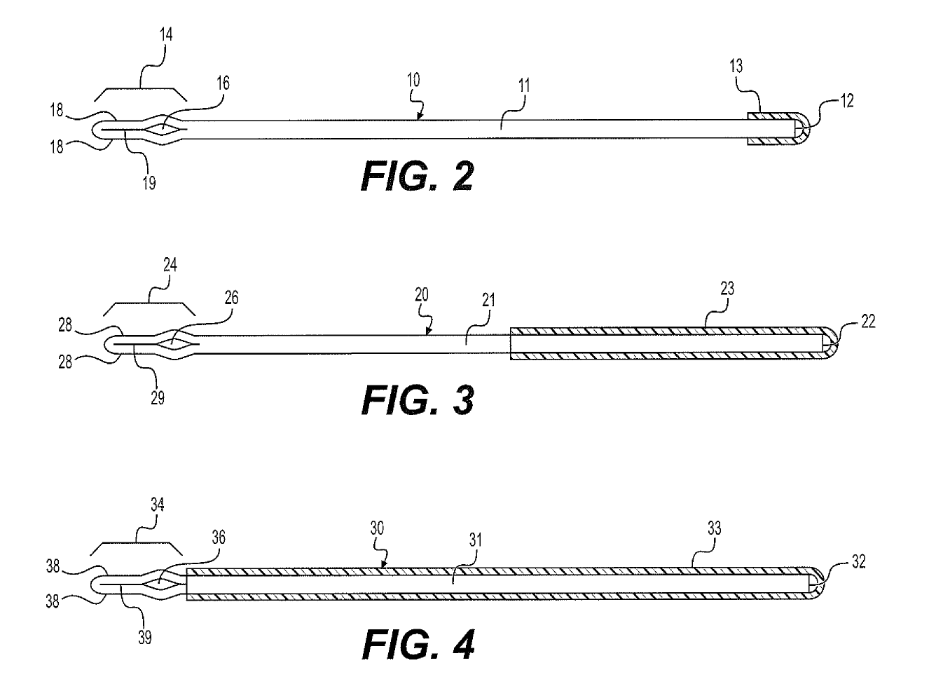

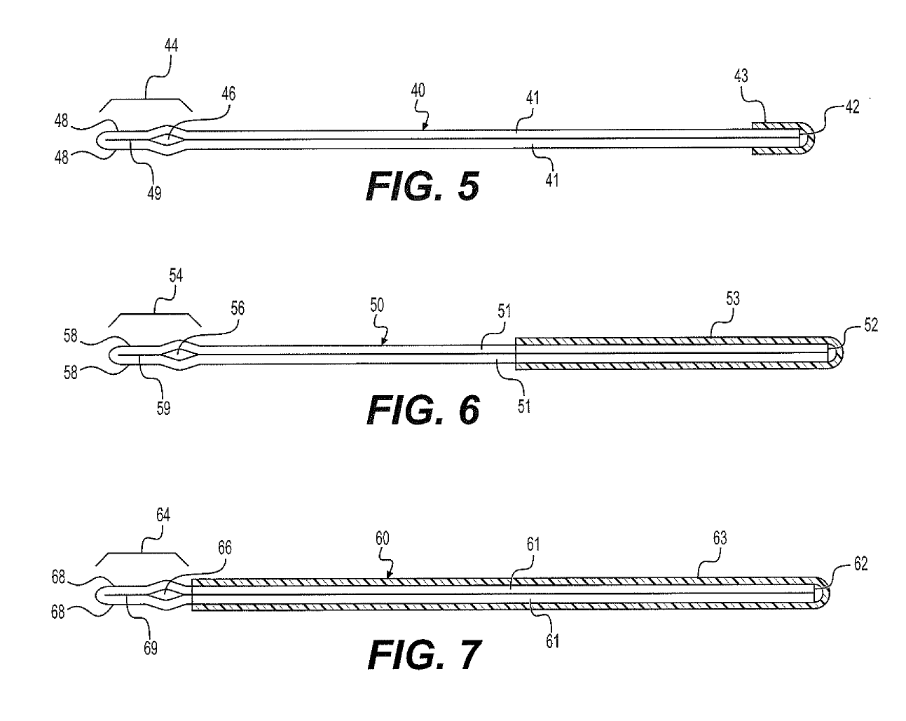

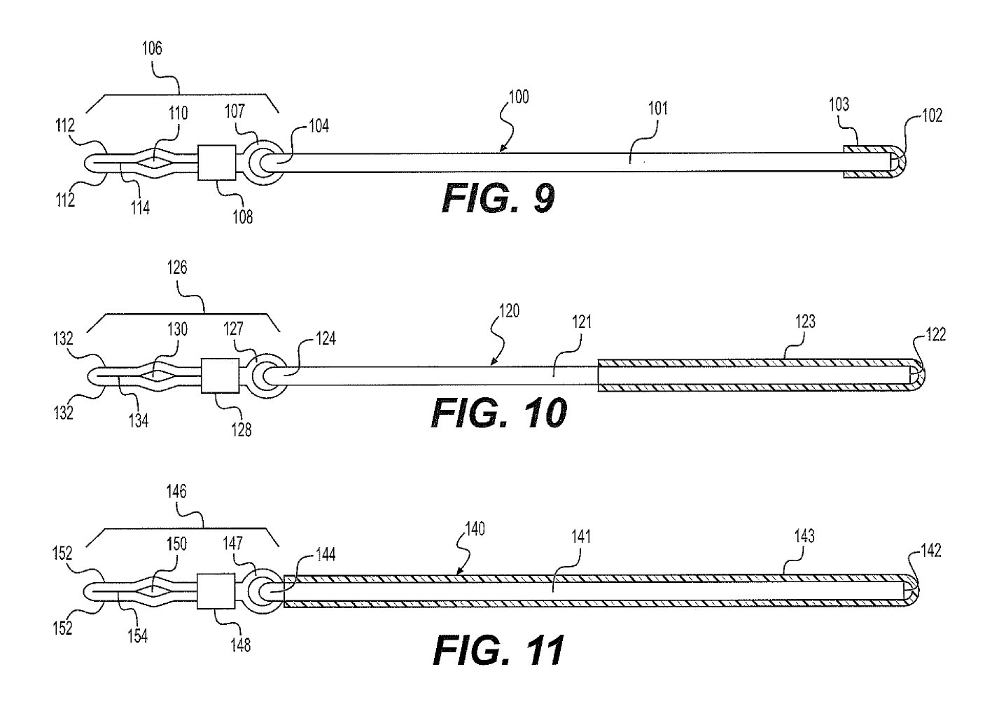

Turning now to the figures, the example line guides in FIGS. 2-7 do not incorporate a swivel option, while the example line guides in FIGS. 9-14 all include a swivel element. Also, generally, speaking, FIGS. 2-4 and 9-11 illustrate line guides having solid, monolithic shafts, while FIGS. 5-7 and 12-14 illustrate examples of a wire that is bent and formed to create a shaft that is made up of two adjacent, parallel lengths of wire.

Referring first to FIGS. 2-4, there are shown line guides 10, 20 and 30 that are monolithic pieces of metal. In one example, the shafts 11, 21 and 31 are formed of stainless steel or aluminum. The guides 10, 20 and 30 include a front end 12, 22 and 32 respectively. These front ends 12, 22 and 32 are blunt or rounded or otherwise beveled so that they do not have a sharp end that could be dangerous. Guide 10 includes a plastic coating or powder coating 13 around only a small portion of the shaft 11 near the front end 12. Line guide 20 includes a plastic or powder coating 23 that covers approximately half of the length of the shaft 20 on the end including the front end 22 of the guide. In the example line guide 30, a plastic coating or powder coating 33 covers substantially the entire length of the shaft 31 from the front end 32 back to the clip end 34.

Line guides 10, 20 and 30 also include back ends 14, 24, and 34 respectively. The back ends 14, 24 and 34 include apertures 16, 26 and 36 formed therein. These apertures 16, 26 and 36 are formed in the shafts 11, 21 and 31 and are adapted to receive a fishing line threaded through that aperture. A line clamp 19, 29 and 39 is defined by clamp side portions 18, 28 and 38 that are adjacent each other. The clamp 19, 29 and 39 is defined by the converging clamp side portions 18, 28 and 38 that define a gap that is sized to receive and pinch/retain a fishing line that is pulled therein. The clamp 19, 29 and 39 may define a very narrow gap or, alternatively, may include sides that are touching each other. In any event, the clamp 19, 29 and 39 defines a gap that extends through the body of the respective guides 10, 20 and 30. The apertures 16, 26 and 36 include a converging v-slot that ends in the respective clamps 19, 29 and 39.

In the examples set forth in FIGS. 5-7, there are line guides 40, 50 and 60. These guides are formed of a pair of parallel wires 41, 51 and 61 respectively. This pair of wires 1, 51 and 61 forms the shaft of the respective line guides 40, 50 and 60. The guides 40, 50 and 60 also include front ends 43, 53, and 63. Plastic coatings or powder coating 43, 53, and 63 is illustrated along various lengths of the respective guides 40, 50 and 60 respectively.

The back ends 44, 54 and 64 include apertures 46, 56, and 66 through which a fishing line may be threaded. The apertures 46, 56 and 66 include a v-shaped groove that ends in the respective clamps 49, 59, and 69 formed by the two end wire side portions 48, 58 and 68. As in the earlier examples, these pairs of wires 48, 58 and 68 may define a narrow gap therebetween, or alternatively maybe touching each other.

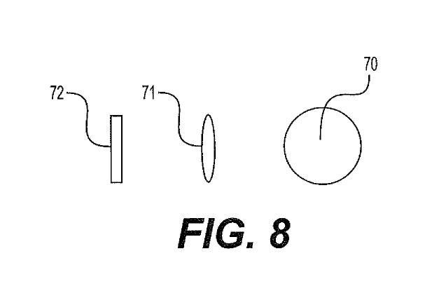

FIG. 8 illustrates end views of alternative line guide examples. Line guide 70 illustrates a solid round cross section. Line guide 71 has an oval or rounded end cross section. Line guide 72 illustrates a generally rectangular cross section.

Turning now to FIGS. 9-14, these lines guides include swivel functionality. Referring first to the guides in FIGS. 9-11, those guides 100, 120 and 140 have shafts 101, 121, and 141. Each of the guides 100, 120 and 140 has a front end 102, 122 and 142. Each of the shafts 101, 121 and 141 includes a plastic or powder coating 103, 123 and 143 as shown as coating of various portions or lengths of the respective shafts. The shaft ends 104, 124 and 144 include apertures to receive rings 107, 127 and 147 that attach to a swivel collar 108, 128 and 148. The back ends 106, 126 and 146 include that swivel functionality and also apertures 110, 130 and 150. In each example shown, there is a wire that is bent and doubled back on itself to create a clamp side portions 112, 132 and 152 that define the line clamps 114, 134 and 154.

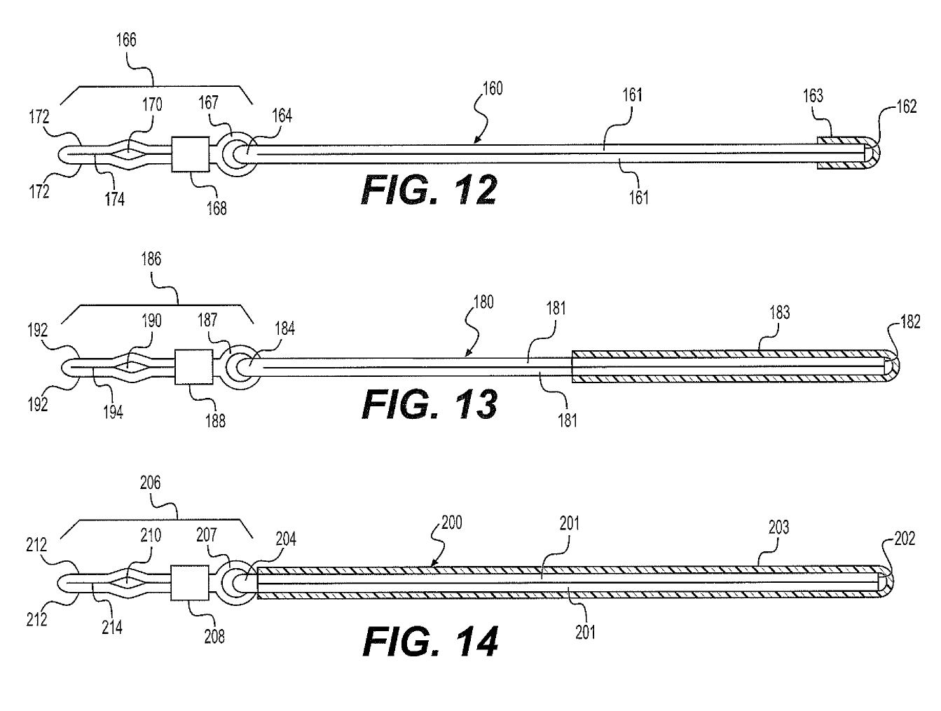

Turning now to FIGS. 12-14, line guides 160, 180 and 200 are formed from a single wire folded on itself or two wires that are parallel to each other 161, 181 and 201. This wire shaft 161, 181 and 201 includes a front end 162, 182 and 202 and further is shown having a coating 163, 183 and 203 along various lengths of the respective shafts. The shaft ends 164, 184 and 204 include holes to receive the rings 167, 187 and 207 that make up a portion of the guide back ends 166, 186 and 206. Also shown are swivel collars 168, 188 and 208 that are connected to a clamp 174, 194 and 214 created between clamp side portions 172, 192 and 212. Apertures 170, 190 and 210 are open so that fishing line may be threaded there through.

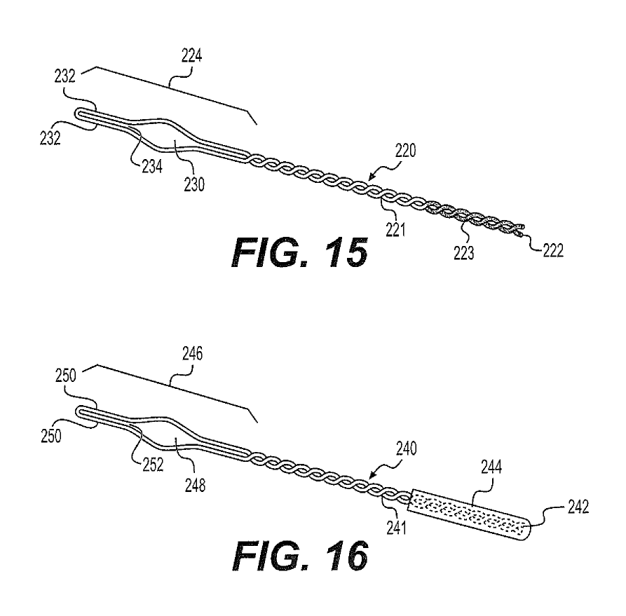

FIGS. 15 and 16 illustrate line guides 220 and 240 that include twisted wire shafts 221 and 241. Those shafts 221 and 241 include front ends 222 and 242. Front section 223 of shaft 221 is coated with a dye or paint or powder coat to color the end of the line guide 220. Line guide 24 includes a plastic coating 244 around the front tip 242.

The back ends 224 and 246 include apertures 230 and 248. Side clamp portions 232 and 250 define the line clamps 234 and 252. In one example of the types of line guides shown in FIGS. 15 and 16, the wires that form those line guides is a relatively narrow guage that has some flexibility. These line guides might be used, for instance with especially small guide hole that a rod may have. Regardless, the wire gauge in wires that may make up a line guide may be chosen for their stiffness or flexibility or their size depending on the intended use of the line guide.

Other embodiments of the present invention will be apparent to those skilled in the art from consideration of the specification. It is intended that the specification and Figures be considered as exemplary only, with a true scope and spirit of the invention being indicated by the following claims.

That which is claimed is:

1. A fishing line guide comprising:
a narrow elongate shaft having a front end and a back end, wherein the front end is blunted;
the back end of the shaft comprises a line clamp, wherein the line clamp comprises an aperture and converging clamp side portions that form a v-slot therebetween;
wherein the v-slot is adapted to physically pinch a fishing line in between the clamp side portions with a friction grip;
whereby a fishing line is adapted to be releasably secured in the clamp end of the line guide to enable a user to efficiently position the fishing line in the guide holes of a fishing rod.

2. A fishing line guide as described in claim 1,
wherein the converging clamp side portions that form the v-slot are formed of a single, monolithic and substantially rigid metal piece.

3. A fishing line guide as described in claim 1,
wherein the converging clamp side portions that form the v-slot are formed of a pair of metal wire sections.

4. A fishing line guide as described in claim 1,
wherein the converging clamp side portions that form the v-slot are formed of a single metal wire section that is bent to create the v-slot.

5. A fishing line guide as described in claim 1,
wherein the elongate shaft is formed from a single, rigid, monolithic metal piece.

6. A fishing line guide as described in claim 1,
wherein the elongate shaft is formed from a single bent wire with a pair of parallel wire portions.

7. A fishing line guide as described in claim 1,
wherein the elongate shaft is formed from a single bent wire with a pair of twisted wire portions.

8. A fishing line guide as described in claim 1,
wherein the elongate shaft is coated at least in part.

9. A fishing line guide as described in claim 8,
wherein the coating is a dye.

10. A fishing line guide as described in claim 8,
wherein the coating is a plastic coating.

11. A fishing line guide as described in claim 1,
wherein the aperture portion of the line clamp has an opening width of about 0.5 to 3 mm.

12. A fishing line guide as described in claim 1,
wherein the maximum cross-sectional width of the line guide is about 2 to 5 mm.

13. A fishing line guide as described in claim 1,
wherein the back end of the shaft further comprises a swivel that is positioned adjacent the line clamp toward the front end of the shaft from the line clamp.
